(19) United States
(12) Patent Application Publication
(10) Pub. No.: US 2021/0305861 A1
(43) Pub. Date: Sep. 30, 2021

(54) STATOR, ROTOR AND ELECTRIC MACHINE

(71) Applicant: FEAAM GmbH, Neubiberg (DE)

(72) Inventor: Gurakuq DAJAKU, Neubiberg (DE)

(21) Appl. No.: 17/213,104

(22) Filed: Mar. 25, 2021

(30) Foreign Application Priority Data
Mar. 27, 2020 (DE) 102020108516.8

(51) Int. Cl. H02K 1/27; H02K 1/16; H02K 1/14

(52) U.S. Cl. CPC H02K 1/2713; H02K 1/02; H02K 1/148; H02K 1/16

(57) ABSTRACT

A stator for an electric machine comprises at least three modules distributed along the circumference of the stator, wherein the modules each carry a coil of a multi-phase tooth-concentrated winding, and wherein the modules including the coils are each covered in the axial direction by a stator cover. A rotor for an electric machine comprises at least two magnets distributed along the circumference of the rotor, in which the magnetic flux closes mainly in the axial direction and to a lesser extent in the circumferential direction through a respective adjacent magnet.

### BACKGROUND OF THE INVENTION

The present disclosure relates to a stator, a rotor, and an electric machine having such a stator and such a rotor.

Electrical machines have been of great importance from the earliest times and are becoming more and more important nowadays. Electrical machines usually are composed of two main components, namely a stationary part, the stator, and a rotating part, the rotor. Both components of the stator and rotor include magnetic material. A small region exists between the stator and the rotor, which is referred to as the air gap. A conventional stator structure has a number of slots or recesses distributed along the circumference in the vicinity of the air gap region, into which coil windings are inserted. The coil windings are, for example, distributed overlapping windings or tooth-concentrated windings.

In conventional electric machines or in the stators of such machines, the ends of the windings usually project beyond the iron core of the stator, so that they are outside the axial length of the stator and cannot contribute to the torque. Therefore, in such electrical machines, only the axial length of the iron core of the stator contributes to the generation of electromagnetic torque. This length is therefore usually referred to as the active length of the electrical machine.

The currents flowing through the windings generate unnecessary ohmic losses in the end region. Furthermore, especially for applications with limited space in the axial direction, the lengths of the winding ends can become relatively large in relation to the total length of the windings or the active length of the electrical machine.

### SUMMARY OF THE INVENTION

The present disclosure provides an improved concept for electrical machines, with which a higher efficiency of the electrical machine can be achieved.

The improved concept is based, firstly, on the idea of designing the stator windings of an electric machine in such a way that all winding components of the coils can be located within the active length of the stator. For this purpose, at least three modules are provided, each of which carries one such coil of a multiphase tooth-concentrated winding. In addition, corresponding stator covers are provided in the axial direction on each side, which cover the coils. The modules with the coils are thereby distributed along the circumference of the stator. In particular, the stator covers ensure that all areas of the coil, i.e. both those extending along the circumference and those extending in the axial direction, including corresponding transitions, are arranged within the active length of the stator. The active length of the stator is thereby derived from the axial length of the modules as well as the axial lengths of the stator covers.

The improved concept is also based on the idea of distributing the magnets along the circumference of a rotor and selecting their polarization so that the magnetic flux closes mainly in the axial direction and to a lesser extent in the circumferential direction through a respective adjacent magnet. Thus, the magnetic flux runs adapted to a winding area of the coils extending along the circumference.

Finally, the improved concept enables the design of an efficient electrical machine in which the design of the stator with its coils can be favorably adapted to the geometry of the rotor with its magnets, and vice versa.

According to one embodiment, a stator for an electric machine comprises at least three modules distributed along the circumference of the stator. The modules each carry a coil of a multiphase tooth-concentrated winding. Thereby, the modules including the coils are each covered by a stator cover in the axial direction. For example, each module is formed by a stator tooth and a coil extending around the stator tooth.

For example, the stator covers are arranged to generate effective flux during operation of the electric machine and thus contribute to the generation of torque. For example, the stator covers can effectively guide the magnetic flux generated by the circumferentially extending sections of the coils. These sections may also be referred to as winding heads.

In various embodiments, the stator covers each have a slot opening and/or a slot between the modules. In particular, the slot openings are formed at the periphery of the stator covers, while the slots extend mainly in the radial direction.

The coils are, for example, substantially rectangular in shape. This is intended to express in particular that regions of the coils extending in the axial direction meet perpendicularly or substantially perpendicularly with the parts of the coils extending along the circumference. Necessary bending radii of the windings at the corners of the coil are to be taken into account and do not change the essential rectangular shape. This also includes, for example, that if there are exactly three modules in a stator, the coils may be arcuate in axial plan view. In the case of a higher number of modules, this course may also be rectilinear, so that the circumference is mapped in a polygonal manner by the coils.

In various embodiments, a length of the coils along the circumference of the stator is greater than a length of the coils in the axial direction. In particular, this allows stators with a short axial extent to be developed, e.g., when only exactly three modules are used. However, with a higher number of modules, this relationship can be reversed, since as the number of modules increases, the length along the circumference becomes shorter.

The modules and/or the stator covers comprise, for example, iron, steel, soft iron and/or soft magnetic composites, SMC. For example, the modules, in particular the stator teeth and/or the stator covers, are formed as a solid material with one or more of the materials mentioned. This offers advantages over conventional laminated steel cores, for example, in terms of material costs, production and three-dimensional, isotropic ferromagnetic properties.

Each module is associated with, for example, an electrical phase of a multiphase electrical system connectable to the multiphase tooth-concentrated winding.

In one embodiment, a rotor for an electric machine comprises at least two magnets distributed along the circumference of the rotor. The magnetic flux of these magnets closes mainly in the axial direction and to a smaller extent in the circumferential direction through a respective adjacent magnet. For example, the number of magnets of the rotor is a multiple of 2. In this case, the magnets are located, for example, in or on a rotor core.

In conventional electric machines, the optimum number of pole pairs usually depends on the diameter of the electric machine. Accordingly, higher numbers of pole pairs are usually more suitable for large rotor diameters. However, such machines with higher numbers of pole pairs are less suitable for high-speed applications, considering that the supply frequency or iron losses increase linearly or quadratically with the number of pole pairs. Accordingly, the rotor is designed, for example, with only two poles, thus comprising one pole pair.

As the magnetic flux mainly closes in the axial direction, this flux is distributed over the entire circumference of the rotor. Thus, the effective length of the rotor in the axial direction is of less importance for the flux, especially in comparison with conventional rotors.

For example, in the rotor, respective magnets adjacent in the circumferential direction comprise different orientations of their polarity. For example, the orientation of the magnetic dipoles of the magnets is alternating.

The closed flux in the axial direction can be achieved, for example, by the magnets being magnetized in the radial direction. For example, the magnets each comprise an outwardly directed first polarity and an inwardly directed second polarity in the radial direction. Thus, for example, a magnetic north pole is directed radially inward, while a magnetic south pole is directed radially outward, or vice versa.

In such an embodiment with radially magnetized magnets, the rotor further comprises, for example, at least two further magnets distributed along the circumference of the rotor, which are arranged adjacent to the at least two magnets in the axial direction, in particular adjacent in pairs. For example, at least four further magnets are thus provided axially adjacent to the at least two magnets. The further magnets are preferably also magnetized in the radial direction and comprise opposite polarity with respect to their neighbor in the axial direction.

With exactly two magnets and correspondingly exactly four further magnets, the two magnets are arranged centrally in the axial direction between the four further magnets. The central magnets are wider in the axial direction than the outer magnets. With such an arranging, the magnetic flux thus continues to close mainly axially with some radial components. The principle does not change with a higher number of pole pairs.

In the embodiment without further magnets, the magnetic flux closes, for example, via the rotor tooth or teeth of the rotor core, which are arranged axially adjacent to the at least two magnets.

In another embodiment, the rotor comprises at least two pairs of magnets distributed along the circumference of the rotor. In this case, the magnets are magnetized in the axial direction. Further, axially adjacent magnets comprise different orientations of their polarity. Axial magnetization is understood to mean, in particular, that the magnets each comprise a first polarity in the axial direction and a second polarity in the opposite direction thereto. For example, the pairs are each inserted into the rotor core at a distance from one another.

Due to this polarization in the axial direction, it directly results that the magnetic flux closes mainly in the axial direction.

According to the improved concept, an electric machine comprises a stator according to any of the embodiments previously described and a rotor according to any of the embodiments previously described. For example, the spatial dimensions of the rotor and the stator are adapted to each other. In this respect, particularly for example the dimensions of the coil, in particular its axial width, are adapted to the dimensions of the magnets of the rotor, in particular their width or their distance from each other.

Such an electric machine can be developed with small axial extension, so that such an electric machine is suitable in particular for applications with limited space.

On the other hand, the axially narrow design of the electric machine enables the use of two or more such electric machines with a narrow design to provide a modular arrangement with a correspondingly higher torque. Accordingly, such a machine comprises a further stator and a further rotor of the type described, which are respectively arranged in the axial direction adjacent to the stator and the rotor. The two modules formed by the rotor and the stator are thereby of identical construction, for example, but this is not mandatory.

### BRIEF DESCRIPTION OF THE DRAWINGS

The invention is explained in more detail below by means of exemplary embodiments with reference to the drawings. Here, similar elements or elements of the same functions are designated with the same reference signs. Therefore, a repeated explanation of individual elements may be omitted.

In the drawings:

FIGS. 1A and 1B show various representations of a module of a stator,

FIGS. 2A and 2B show various detailed views of a stator,

FIGS. 3A, 3B, 3C show various embodiments of stator covers,

FIG. 4 shows an embodiment of a stator in an exploded view,

FIGS. 5 and 6 show various embodiments of a stator,

FIGS. 7A to 7F show various embodiments of a rotor,

FIGS. 8A, 8B, 8C show various views of an embodiment of an electric machine,

FIGS. 9A to 9D show various views of a further embodiment of an electrical machine,

FIGS. 10A and 10B show various views of a further embodiment of an electrical machine,

FIGS. 11A, 11B, 11C show various views of a further embodiment of an electrical machine,

FIGS. 12A and 12B show various views of a further embodiment of an electrical machine,

FIGS. 13A and 13B show various views of a further embodiment of a stator, and

FIGS. 14A, 14B, and 14C show various views of a further embodiment of an electrical machine.

### DETAILED DESCRIPTION

The improved concept described herein relates, inter alia, to a stator for an electric machine comprising at least three modules distributed along the circumference of the stator. The modules each carry a coil of a multi-phase tooth-concentrated winding. Furthermore, the modules including the coils are each covered in the axial direction by a stator cover.

In the following, the individual components of such a stator as well as the complete stator are first described on the basis of the figures. Furthermore, explanations follow for rotors according to the improved concept as well as for an electric machine formed of stator and rotor.

FIGS. 1A and 1B show different views of a module 1 of a stator, which is formed, for example, by a stator tooth 1′ and a cover. The module further comprises a coil 2, which is shown only schematically in the figures. While the module and the coil 2 are shown separately in FIG. 1, they are joined together in FIG. 1B. The stator tooth 1′ is flattened and the coil 2 is guided around the stator tooth 1′. The coil 2 in this embodiment is substantially rectangular, in particular with orthogonally extending corners. Along the circumference, the coil 2 is bent accordingly. The individual turns of the coil 2 are not shown for reasons of clarity, but correspond to the course shown.

In the embodiment shown, the length of the module along the circumference of the stator is greater than its deflection in the axial direction. This is advantageous for stators with a short axial length, but in principle the ratio can be the reverse or the same.

For example, to allow easy fabrication and to be able to conduct the magnetic flux three-dimensionally, the stator tooth 1′ is formed from a solid material comprising, for example, iron, steel, soft iron and/or soft magnetic composites, SMCs. Such materials are favorable compared to conventional laminated steel cores in terms of material cost, production cost and three-dimensional isotropic ferromagnetic behavior.

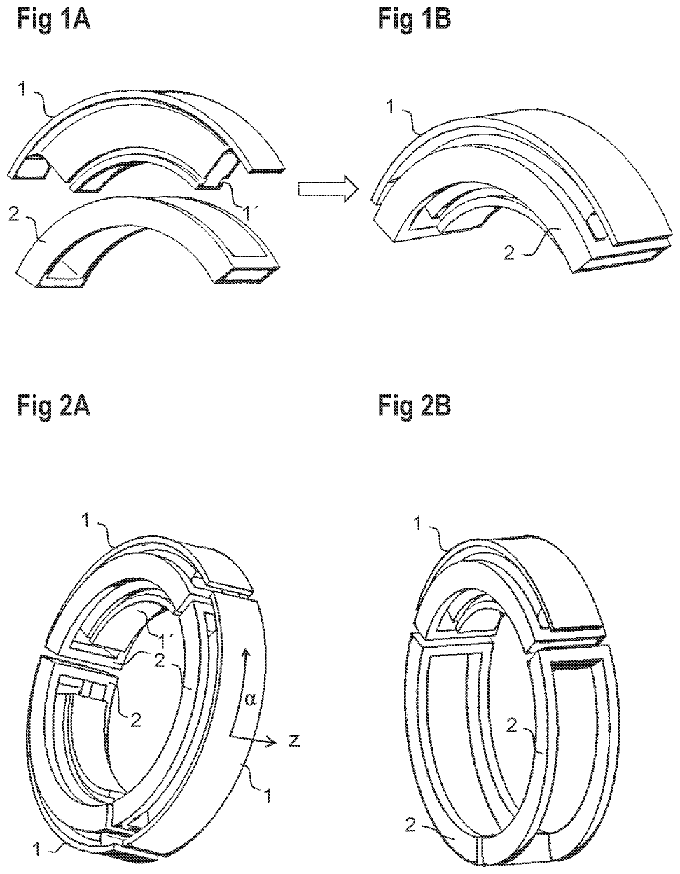

In FIGS. 2A and 2B, three such stator modules are shown together. Here, for example, the three coils 2 form a three-phase system. For clarity, the circumferential direction a and the axial direction z are also shown in FIG. 2A. In FIG. 2B, two of the three module carriers with the stator teeth are not shown for the sake of illustration.

As can be seen from the previous figures, the winding length along the circumference a is significantly greater than the length of the coils in the axial direction z. This means that a substantial part of the magnetic field of the coil 2 is generated in the axially outer end regions of the coils 2, which can also be referred to as winding heads. In order to utilize this magnetic field, according to the improved concept, it is proposed to include this area in the magnetic flux, in which stator covers 3 are placed on both sides of the modules 1 in the axial direction.

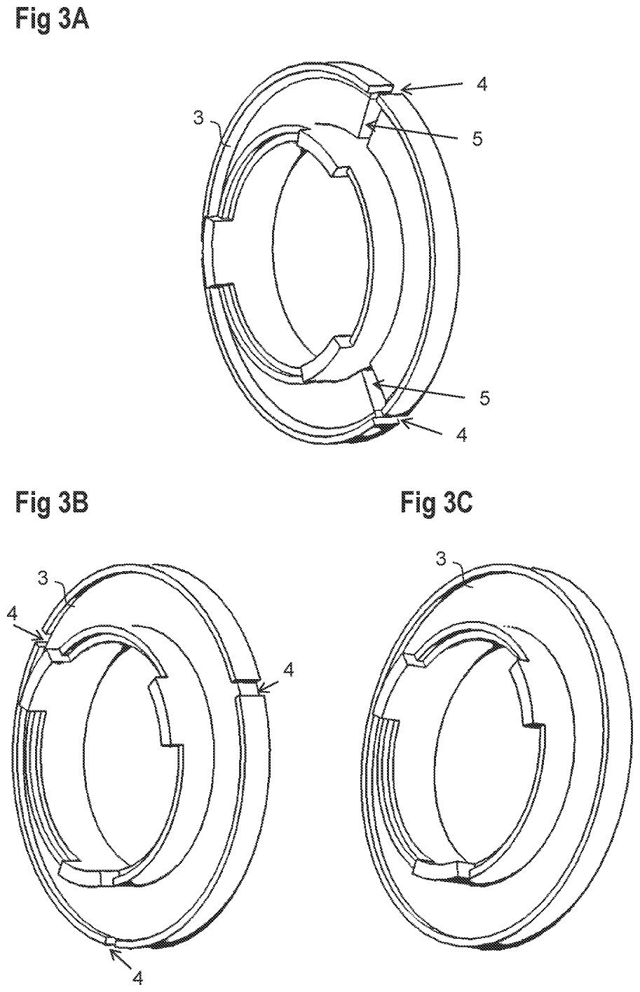

FIGS. 3A, 3B and 3C show various embodiments of such stator covers 3. In the embodiment of FIG. 3A, the stator cover 3 has a slot opening 4 and an underlying, radially extending slot 5, in each case at the points where the modules meet. For perspective reasons, only two slot openings 4 and slots 5 are shown in FIG. 3A.

The stator covers 3 are preferably formed of the same materials as the modules 1, i.e. iron, steel, soft iron and/or SMC. It is possible, but not required, that the materials of the modules 1 and the stator covers 3 are identical.

In FIG. 3B, the stator cover 3 has only corresponding slot openings 4, but no slots 5. In FIG. 3C, the stator cover 3 also has no slot openings 4.

The slot openings 4 or slots 5 can be used, for example, to reduce or avoid magnetic leakage flux.

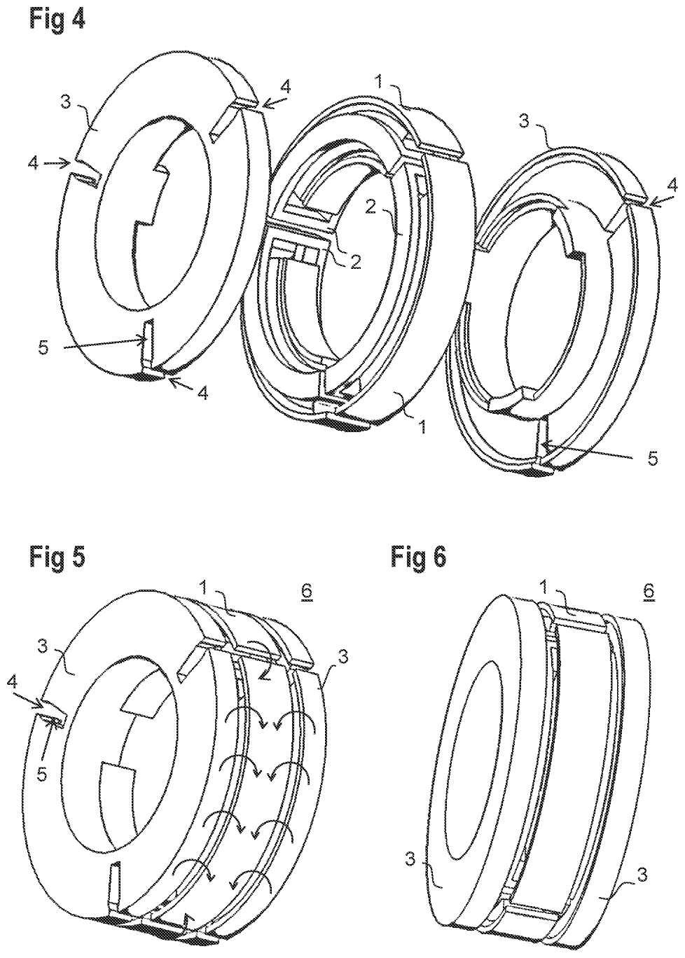

Finally, FIG. 4 shows a complete stator in exploded view, the stator in this embodiment being formed from the modules shown in FIG. 2A and two of the stator covers 3 shown in FIG. 3A. Other combinations will be recognized by the skilled person as alternatives.

Finally, FIG. 5 shows a complete stator 6, based on the implementation of FIG. 4. In FIG. 5, a possible course of the magnetic flux is additionally shown, which results, for example, when the coils 2 have current flowing through them. Here it can be clearly seen that the winding heads of the coils 2, which run along the circumference, generate corresponding magnetic flux via the stator covers 3, which mainly closes in the axial direction between the stator covers 3 and the modules 1. A smaller portion of the flux is generated by the component of the coil 2 running in the axial direction.

Compared to conventional stator arrangements, it should be noted that all components of the coil contribute to the magnetic flux and thus to the generation of torque. This is caused in particular by the stator covers 3, which enclose the parts of the coil running along the circumference and thus generate effective flux when the stator is in operation.

FIG. 6 shows a modified embodiment of a stator 6 in which a stator cover 3 without slot openings 4 or slots 5 is used. In other respects, the effects described above also apply to this embodiment.

The improved concept further proposes a rotor arrangement for an electric machine which is designed for small axial extension and a small number of pole pairs.

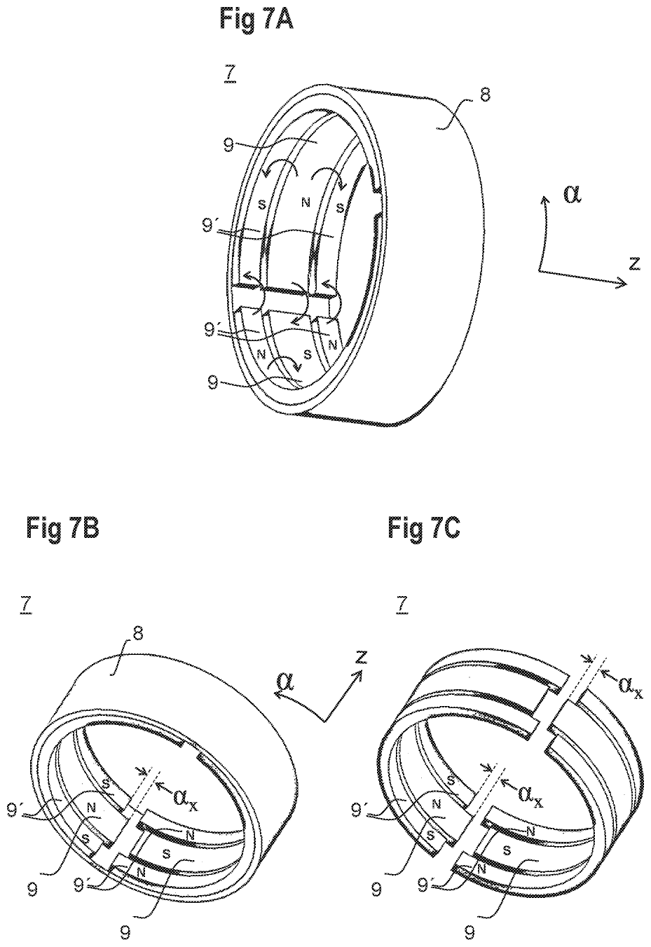

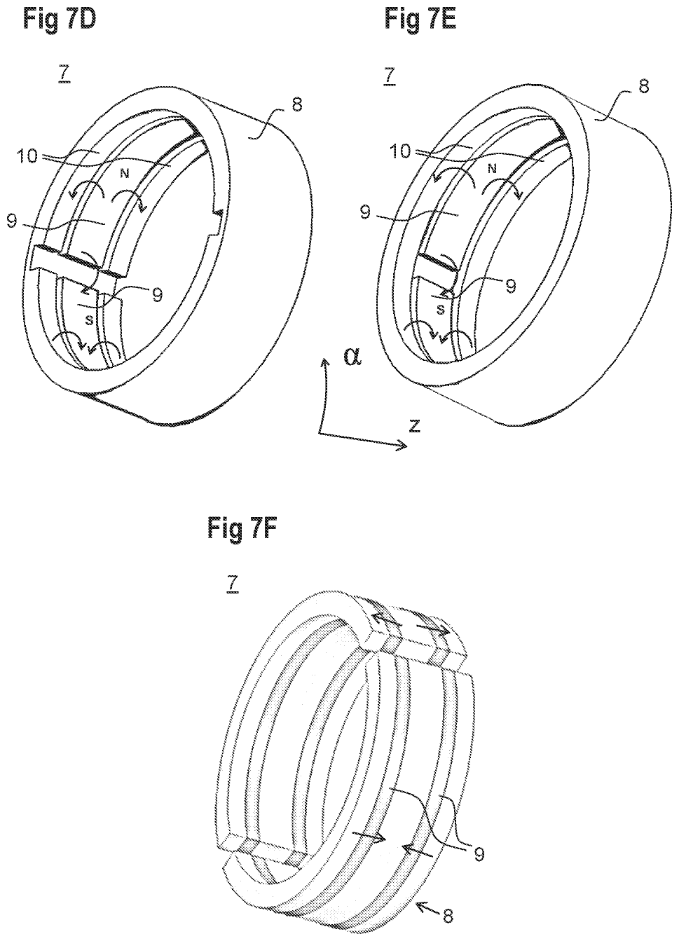

FIGS. 7A to 7F show various embodiments of such rotors 7, each comprising a rotor core 8 and at least two magnets 9 distributed along the circumference of the rotor 7. In the embodiments shown, all rotors 7 are of two-pole design, i.e. with one pole pair. However, the principle described below can also be transferred to higher numbers of pole pairs.

In the embodiment of FIG. 7A, two additional pairs of magnets 9′ are provided in addition to the two magnets 9 which are radially magnetized. Radially magnetized means in particular that the magnets 9 each have an outwardly directed first polarity and an inwardly directed second polarity in the radial direction. The additional pairs of magnets 9′ are each arranged axially adjacent to the magnets 9. The polarity of the outer magnets 9′ is in each case reversed to the polarity of the middle magnet 9. Similarly, respective magnets adjacent in the circumferential direction also have different orientations of their polarity or alternate. Due to the illustrated arrangement of the magnets 9, 9′, the magnetic flux closes mainly in the axial direction and to a smaller extent in the circumferential direction through a respective adjacent magnet. This ensures that the circumference of the rotor plays no role in the magnetic flux and accordingly a low number of pole pairs can be used.

The embodiments of FIGS. 7B and 7C are based on the embodiment of the rotor of FIG. 7A, wherein the outer magnets 9′ each have a slope relative to the central magnets 9, i.e. a displacement in the circumferential direction. For example, this skew is a one-step skew by an angle α, This type of pole shift could be efficient for further improvements in machine performance, such as torque ripple, vibration, etc.

For example, the angle αₓ of the skew is between 0° and 20°, each considered as an electrical angle.

In FIG. 7B the complete rotor 7 is shown, while in FIG. 7C the rotor core 8 is not shown for sake of illustration.

In the embodiments of FIGS. 7D and 7E, in contrast to FIGS. 7A to 7C, only the respective central magnets 9 are present, so that the magnetic flux extends over the adjacent rotor teeth 10. FIGS. 7D and 7E differ in that in the rotor of FIG. 7D the magnets are embedded, so to speak, in a plane with the rotor teeth 10, whereas in FIG. 7E the magnets 9 are arranged in a raised position with respect to the rotor teeth 10. Nevertheless, in both embodiments there is an analogous behavior with respect to the magnetic flux in relation to the embodiment of FIG. 7A.

In the embodiment of FIG. 7F, two pairs of magnets 9 magnetized in the axial direction are provided in the split rotor core 8, the polarizations of the magnets 9 of one pair being different. This is also evident from the corresponding arrows representing the magnetic flux. Despite the different polarization of the magnets 9, a closing of the magnetic flux mainly in axial direction results.

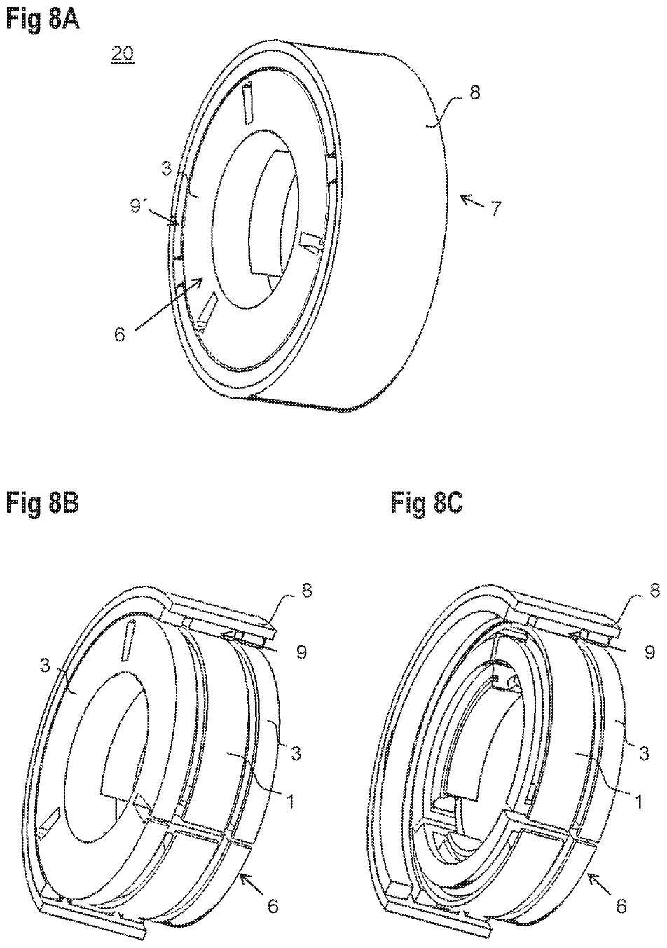

The stator and the rotor according to the improved concept can be assembled together to form an electric machine. Various embodiments for this are described below with reference to the drawings. In principle, it is advantageous here if the geometries of the stator and the rotor are adapted to each other, for example with respect to the dimensions of the coils 2 and the magnets 9 and, if present, 9′, respectively. For example, in FIGS. 8A, 8B and 8C, various views of an embodiment of an electric machine 20 are shown. For example, FIG. 8A shows the electric machine with an internal stator 6 according to the embodiment described in FIG. 5 and an external rotor 7 according to the embodiment described in FIG. 7A.

In FIG. 8B, a partial sectional view is chosen, in which the external rotor 7 is only half shown, so that the geometrical relationship between the arrangement of the magnets 9 and 9′, respectively, with respect to the coils (not visible) and the modules 1 can be seen. In FIG. 8C, by omitting a stator cover 3, the coils 2 are also visible.

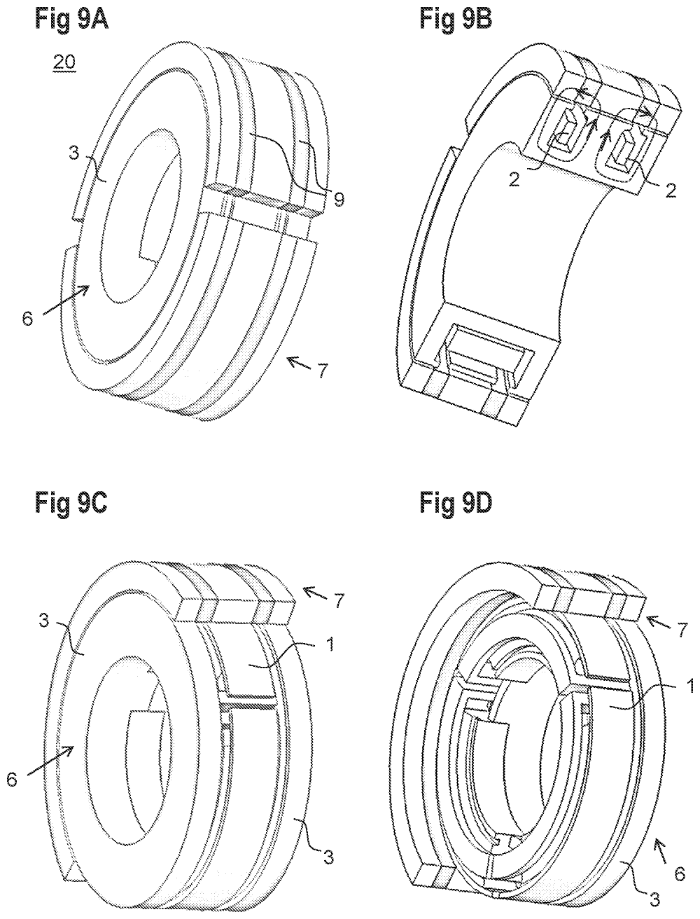

In FIGS. 9A to 9D, various views of a further embodiment of an electric machine 20 are shown, which is designed, for example, with an internal stator 6 as shown in FIG. 6 and an external rotor 7 as shown in FIG. 7F. FIG. 9A shows the electric machine 20 in its overall view. In FIG. 9B, a sectional view is selected in which magnetic flux lines are additionally shown running radially and axially through the stator and the rotor. Here it is readily seen that the parts of the coil running along the circumference contribute fully to the effective flux and thus to the generation of torque.

In FIG. 9C, one half of the outer rotor 7 is omitted for clarity. In FIG. 9D, again one of the stator covers 3 is not shown.

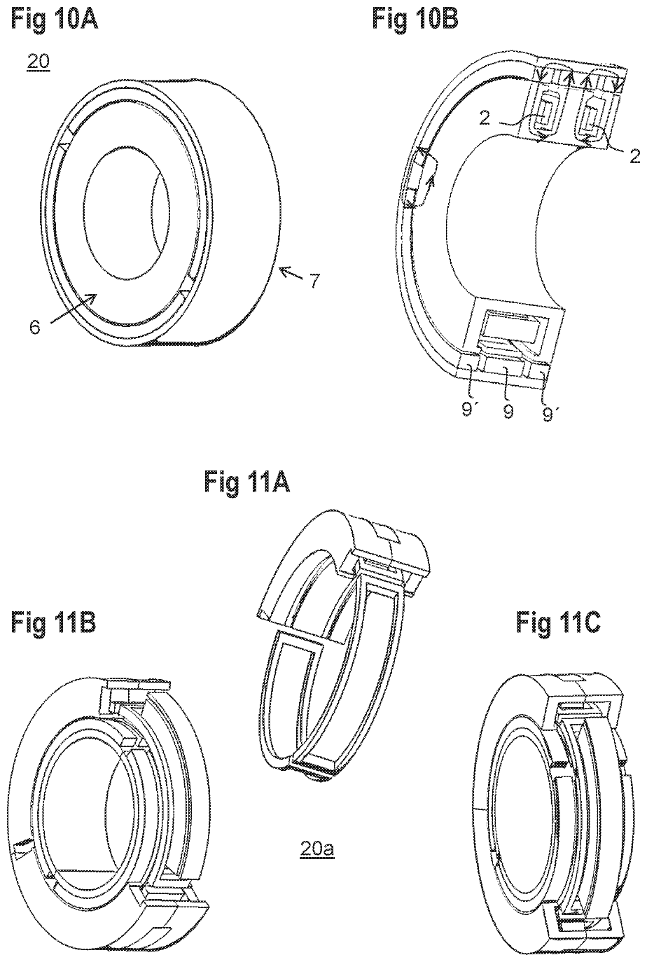

In FIGS. 10A and 10B, a further embodiment of an electric machine is shown in a complete and in a sectional view. Here, for example, the rotor 7 is designed as shown in FIG. 7A, while the stator 6 is designed with stator covers 3 without slots or slot openings, as shown in FIG. 3C, for example. In analogy to FIG. 9B, FIG. 10B again shows the course of the magnetic flux through the coils, which is radial and axial, while a small part of the transition between the two poles of the rotor occurs along the circumference.

In FIGS. 11A, 11B and 11C, embodiments of an electric machine 20a with an internal rotor are shown. In FIG. 11A, a portion of the stator is shown with the three coils and only one stator tooth module. In FIGS. 11B and 11C, the complete electrical machine is shown, with only the cover in one module area not shown.

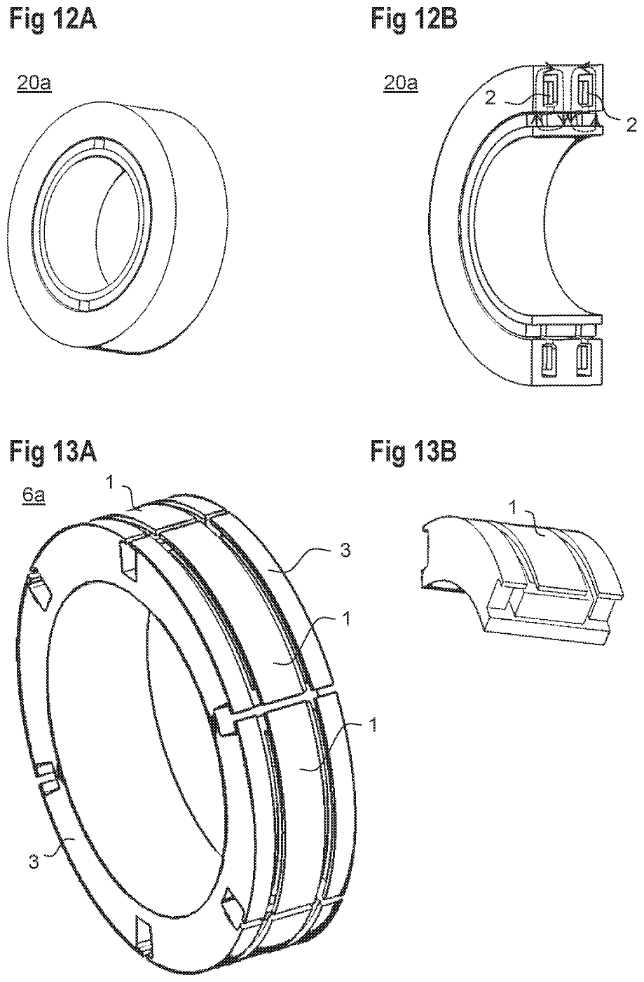

In FIGS. 12A and 12B, a further embodiment of an electric machine 20a with an internal rotor is shown. Here, the stator is formed without slots and the rotor is formed analogously to FIG. 7A, with the magnets directed radially outward.

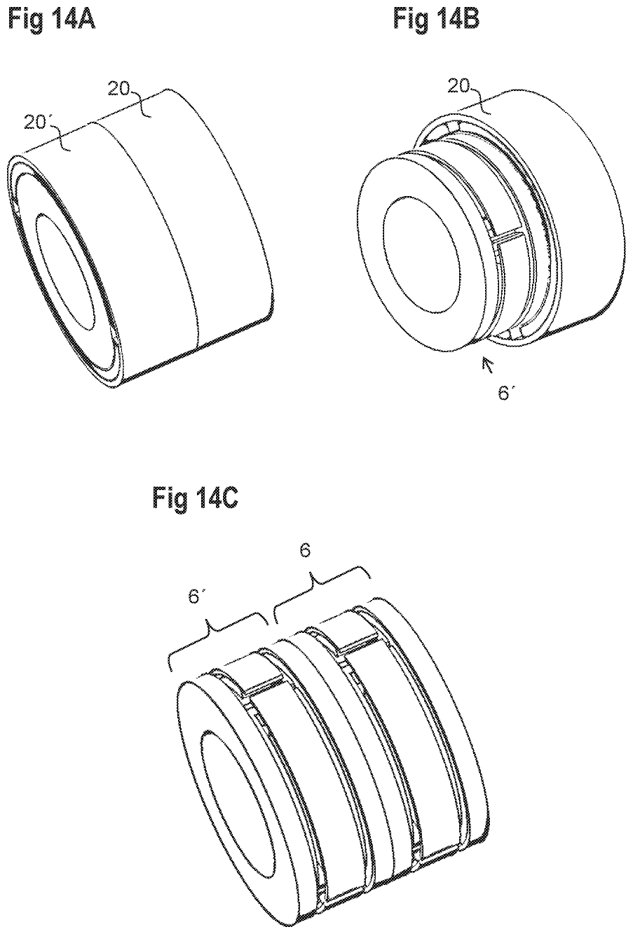

In the previously described embodiments, the stator was shown in each case with three modules or three coils. However, the described approach can also be extended to a larger number of modules. In the embodiment in FIG. 13A, for example, a stator with six modules and correspondingly six coils is shown, whereby the stator covers also have six slots and slot openings accordingly. In FIG. 13B, a single one of the six modules is shown for illustration purposes. Variations corresponding to different designs with three coils or modules are possible.

In FIGS. 14A, 14B and 14C an arrangement is shown formed of two potentially identical electrical machines 20, 20′ according to one of the previously described embodiments. Due to the narrow design, i.e. the small axial extension of the electric machine, several such electric machines can be assembled in a modular manner, for example if a higher torque is required and/or sufficient space is available in the axial direction. Thus, the same motor modules can be used for different applications of different needs.

While FIG. 14A shows the complete arrangement, FIG. 14B does not show one of the external rotors. In FIG. 14C both rotors are omitted and only the internal stators 6, 6′ are shown. Here, the two electric machines are connected to each other in axial direction.

1. A stator for an electric machine, comprising
at least three modules distributed along the circumference of the stator,
wherein the modules each carry a coil of a multi-phase tooth-concentrated winding, and
wherein the modules including the coils are each covered in the axial direction by a stator cover.

2. The stator according to claim 1,
wherein the stator covers are configured to generate effective flux during operation of the machine and thereby contribute to the generation of torque.

3. The stator according to claim 1
wherein the stator covers each comprise a slot opening and/or a slot between the modules.

4. The stator according to claim 1,
wherein the coils are substantially rectangular in shape.

5. The stator according to claim 1,
wherein the modules and/or the stator covers comprise iron, steel, soft iron and/or soft magnetic composites.

6. The stator according to claim 1,
wherein each module is associated with an electrical phase of a multi-phase electrical system connectable to the multi-phase tooth-concentrated winding.

7. A rotor for an electric machine,
comprising at least two magnets distributed along the circumference of the rotor, for which magnets the magnetic flux closes mainly in the axial direction and to a lesser extent in the circumferential direction through a respective adjacent magnet.

8. The rotor according to claim 7,
which is designed with two poles.

9. The rotor according to claim 7,
wherein respective circumferentially adjacent magnets have different orientations of their polarity.

10. The rotor according to claim 7,
wherein the magnets are magnetized in a radial direction and, in particular, each have an outwardly directed first polarity and an inwardly directed second polarity in the radial direction.

11. The rotor according to claim 10,
further comprising at least two further magnets distributed along the circumference of the rotor, which are arranged adjacent in the axial direction, in particular adjacent in pairs, to the at least two magnets.

12. The rotor according to claim 7,
which comprises at least two pairs of magnets distributed along the circumference of the rotor, wherein
the magnets are magnetized in the axial direction and, in particular, each have a first polarity and a second polarity directed oppositely thereto in the axial direction; and
axially adjacent magnets have different orientations of their polarity.

13. An electric machine comprising a stator according to claim 1 and a rotor according to claim 7.

14. The electric machine according to claim 13, comprising a further stator according to claim 1 and a further rotor according to claim 7, each arranged axially adjacent to the stator and the rotor.
